(19) United States
(12) Patent Application Publication
(10) Pub. No.: US 2011/0017392 A1
(43) Pub. Date: Jan. 27, 2011

(54) MECHATRONIC GUN FOR TAPING A HARNESS

(76) Inventor: Dania Nevarez Erives, Chihuahua (MX)

Correspondence Address: ST. ONGE STEWARD JOHNSTON & REENS, LLC, 986 BEDFORD STREET, STAMFORD, CT, 06905-5619, US

(21) Appl. No.: 12/712,953

(22) Filed: Feb. 25, 2010

(30) Foreign Application Priority Data
Mar. 3, 2009 (MX) MX/A/2009/002638

(51) Int. Cl. B32B 38/00

(52) U.S. Cl. 156/250; 221/30; 156/443

(57) ABSTRACT

A portable mechatronic tape gun for the automatic taping of a single spot on a wire harness by a user. A user places the drum of a mechatronic taping gun over a wire harness and actuates an activation button on a handle. The actuation of the activation button causes a rotational movement in the drum. The rotational movement of the drum causes tape to be cut and rolled around the wire harness. The user then removes the mechatronic taping gun from the harness, and moves to a different spot on the wire harness for additional taping of the wire harness.

### CROSS-REFERENCE TO RELATED APPLICATIONS

The present application claims priority of Mexican patent application No. MX/a/2009/002638 filed on Mar. 3, 2009, the content of which is incorporated herein by reference.

### FIELD OF THE INVENTION

The present invention relates to a mechatronic gun for taping wire harnesses in a single spot. More specifically, the mechatronic gun provides for multiple spot taping on a single wire harness.

### BACKGROUND OF THE INVENTION

In a factory, such as the maquila industry in the North of Mexico, a one-spot taping process is used to tape a harness, a set of wires with various devices for interconnecting electrical systems. Multiple passes of tape are manually rolled over a single spot on the wire harness, and then manually cut by the roller. A single harness can require many spot taping procedures to be performed across the entire harness. This requires a lot of attention to be paid to a specific area of the harness, which causes a bottle neck in the work performed as it can take a worker at minimum 4 seconds to tape a single harness spot. Some harnesses require up to 30 tapings across the entire harness, therefore, requiring over 120 seconds to tape a single harness. Also, as each taped spot is manually rolled and cut, workers are prone to mistakes and a significant deviation in quality exists over each taped spot. This process provides a loss in productivity, time, and is an excessive waste of taped material as each piece of tape used in a single spot is not sized perfectly for that spot.

It is thus desirable to develop a mechatronic taping gun to increase productivity, decrease the time to tape a single spot, and decrease waste.

### SUMMARY OF THE INVENTION

The mechatronic gun is an instrument intended to meet the needs of the harness industry or of any other industry involved in taping or packing. This mechatronic gun replaces the manual application of tape in a single spot allowing for the faster application any type of adhesive tape used by the customer in a single spot taping procedure.

A worker introduces the wire harness into the mechatronic gun, applying tape with adhesive in the same place, cutting it automatically with the cutting elements. The tape is cut in triangles making it easy to see. The tape is adhered with a flexible device that adapts perfectly to the geometric shape of the harness. The gun is 100% portable, 115 V AC, 60 Hz, and can weigh as little as 2.037 kg. This allows the worker to reduce time from 4 to 1.5 seconds per tape rolling application. The machine allows the user to adjust the length of the tape to be applied as required by the customer. The mechatronic gun may be used to tape harness with a diameter as small as ⅛ of an inch.

In a preferred embodiment, the mechatronic taping gun is an electrically and mechanically operated single-spot taping tool for spot-taping an electrical harness. The design allows a worker to tape a single spot more quickly and efficiently, and without wasting anymore tape than needed for a particular spot. In a preferred embodiment, the mechatronic tool is in the shape of a gun, allowing ease of grip and use by one hand of a single person.

In a preferred embodiment, the gun comprises a support structure housing a motorized drum, with a handle and a tape roller attached to the drum. The support structure and the drum have a radial opening for the insertion of a work piece. The work piece is a wire harness or any other piece that may be laterally inserted into the tape gun. The tape holder dispenses tape in front of the opening of the housing and the drum by extending the tape over a guide roller attached to the housing, and through a slot attached to the housing, such that the tape hangs in front of the opening. The work piece is inserted into the opening, attaching itself to the adhesive side of the tape. A switch is activated causing the motorized drum to rotate with respect to the housing, cutting the end of the tape at a predetermined length, and causing the tape to be attached to the work piece. During the first rotation, a cutting element cuts the tape to a predetermined length, sized to fit the specific work piece being inserted.

In one embodiment, the switch is a button, a physical switch, a sensor, or any other known way of activating a device.

In one embodiment, an adjustment mechanism can be adjusted to change the length of the tape and the number of rotations of the drum.

### BRIEF DESCRIPTION OF THE DRAWINGS

FIG. 1 is an angled view of the mechatronic taping gun.

FIG. 2 is a side view of the drum after the work piece has been inserted.

FIG. 3 is a side view of the drum after a quarter of a rotation.

FIG. 4 is a side view of the drum after a half of a rotation.

FIG. 5 is an exploded view of a driving system of the mechatronic gun.

FIG. 6 is an exploded view of a cutting and fastening drum of a mechatronic gun.

FIG. 7 is a second exploded view of a cutting and fastening drum of a mechatronic gun.

### DETAILED DESCRIPTION OF THE INVENTION

The exemplary embodiments of the present invention may be further understood with reference to the following description and the related appended drawings, wherein like elements are provided with the same reference numerals.

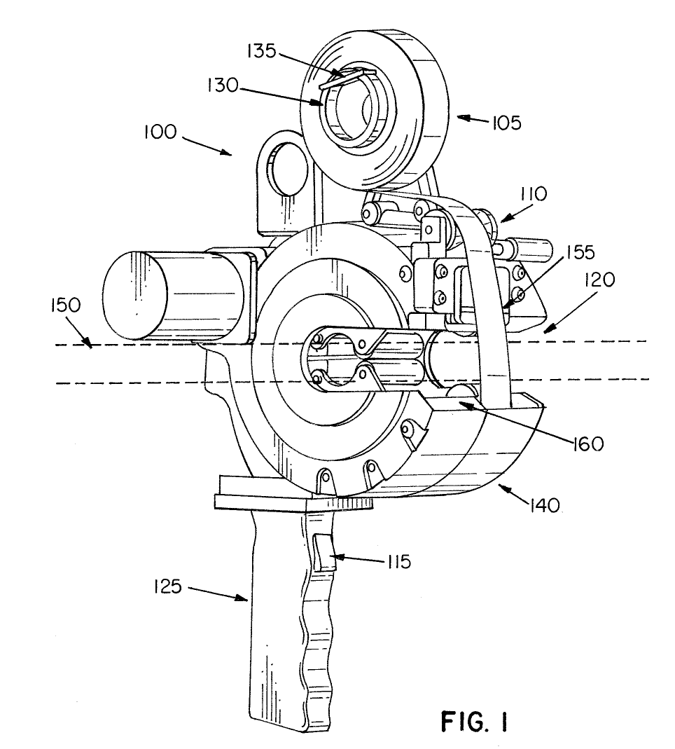

FIG. 1 shows an angled view of mechatronic gun 100. Mechatronic gun 100 includes a handle 125, a drum 140, and a tape holder 130. The user attaches a roll of tape 105 to mechatronic gun 100 by placing tape 105 on to tape holder 130. Tape 105 is then secured to tape holder 130 using clip 135, which holds tape 105 in place during operation of mechatronic gun 100. In a preferred embodiment, tape 105 is electrical tape used to tape a wire harness, represented by dotted lines 150. However, any type of adhesive tape may be employed such as duct tape, packing tape, masking tape, gaffers tape, and plumbers tape, and the size of mechatronic gun 100 and tape holder 130 may be increased or decreased to accommodate different types of tape.

Tape 105 is inserted onto tape holder 105 such that the end portion 145 of tape roll 105 extends from the bottom of tape 105. However, mechatronic gun 100 may be modified such that the end portion 145 of tape roll 105 extends from the top of tape 105. End portion 145 is drawn from tape 105, rotating tape 105 about tape holder 130. End portion 145 is then drawn over guiding roller 110 and through slot 155 which helps keep end portion 145 secured to mechatronic gun 100. Finally, end portion 145 is drawn to a position covering all, or substantially all, of the entire length of opening 120 in mechatronic gun 100.

To operate mechatronic gun 100, the user places their hand (not shown) on to handle 125, gripping mechatronic gun 100. The user then moves mechatronic gun 100 to wire harness 150, inserting wire harness 150 into opening 120 such that wire harness 150 extends laterally through opening 120. During the insertion of wire harness 150 into opening 120, the adhesive side of end portion 145 is attached to wire harness 150. The user actuates activating button 115, located on the front portion of handle 125, while wire harness 150 is drawn through opening 120. It should be noted, however, that activation button 115 may be located on any portion of mechatronic gun 100, and is not limited to the front of handle portion 125. Furthermore, activation of the mechatronic gun may be by a switch, an automatic sensor that determines when wire harness 150 has been inserted into opening 120 of drum 140, or any other means for activating a motorized device.

The actuation of button 115 causes the forward rotation of drum 140 about the wire harness 150. The rotation of drum 140 cuts end portion 145 using a cutting means 160. Drum 140 then grabs the end portion 145, which has been detached from tape 105, and rotates the end portion around wire harness 150. The number of rotations, and thus the amount of tape needed for each spot, can be adjusted by the user for each specific wire harness tape application, by an adjustment mechanism (not shown). Drum 140 makes a minimum of one rotation, causing at least one revolution of tape around wire harness 150. However, drum 140 can make any number of rotations about wire harness 150, providing a more secure taping of wire harness 150, by an adjustment mechanism that can be adjusted at any time. After drum 140 finishes rotating about wire harness 150, and mechatronic gun 100 finishes taping the desired spot on wire harness 150, the user removes wire harness 150 from mechatronic gun 100 through opening 120. The user is then free to apply tape to a different spot on wire harness 150 as mechatronic gun 100 cuts end portion 145 such that another end portion 145 is located across opening 120.

In another preferred embodiment, drum 140 may move in a backwards motion when cutting end portion 145, and securing tape to wire harness 150.

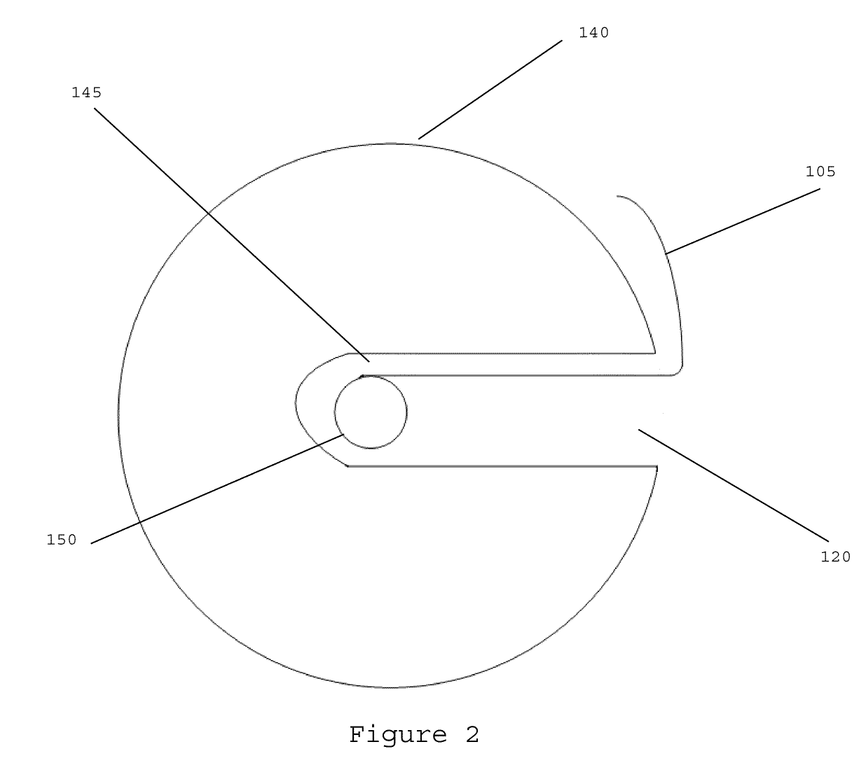

FIG. 2 shows a close-up side view of drum 140 in the starting position. Wire harness 150 is inserted laterally into opening 120 of drum 140. As wire harness is inserted into opening 120, the adhesive portion of the end portion 145 of tape 105 adheres directly to wire harness 150. After wire harness 150 has been inserted, the user is free to activate activation button 115.

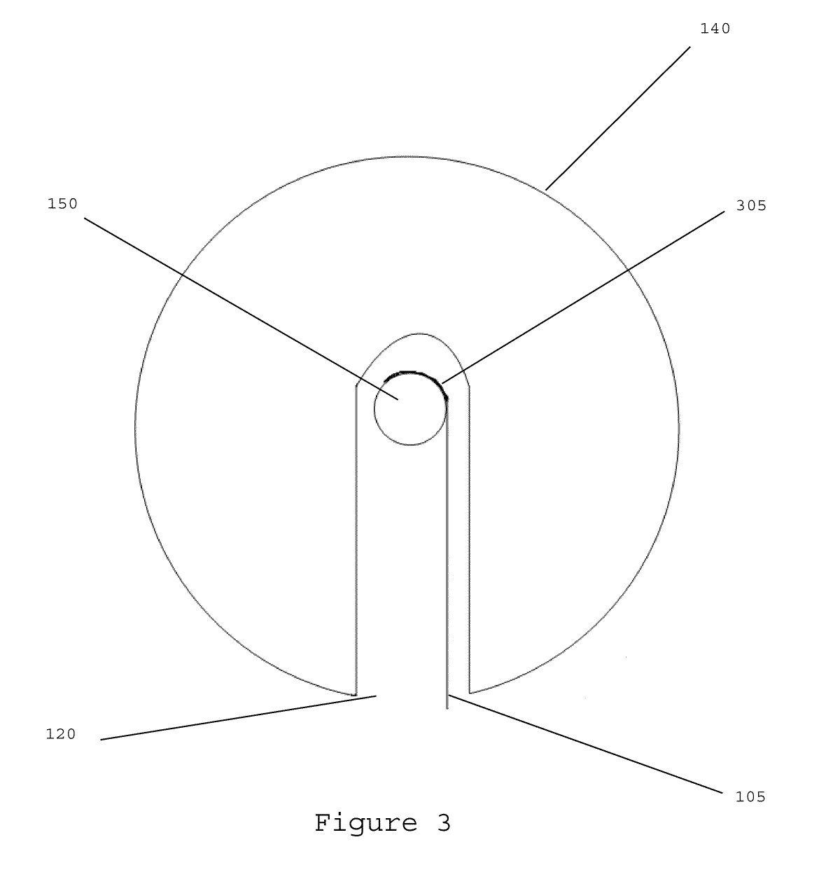

FIG. 3 shows a close-up view of drum 140 after a quarter rotation has been performed. After the user activates actuation button 115, the drum starts its rotation about wire harness 150. After a quarter of a rotation, end portion 305 is partially wrapped around wire harness 150. Cutting element 160 then cuts tape 105 at a predetermined length based on the adjustment by the user. Tape 105, detached from the roll of tape, extends into opening 120, waiting for at least one full rotation to be completely wrapped around wire harness 150. A new end portion 145 is formed from the cutting of tape 105, and is left hanging over the drum such that a further spot taping process can be performed.

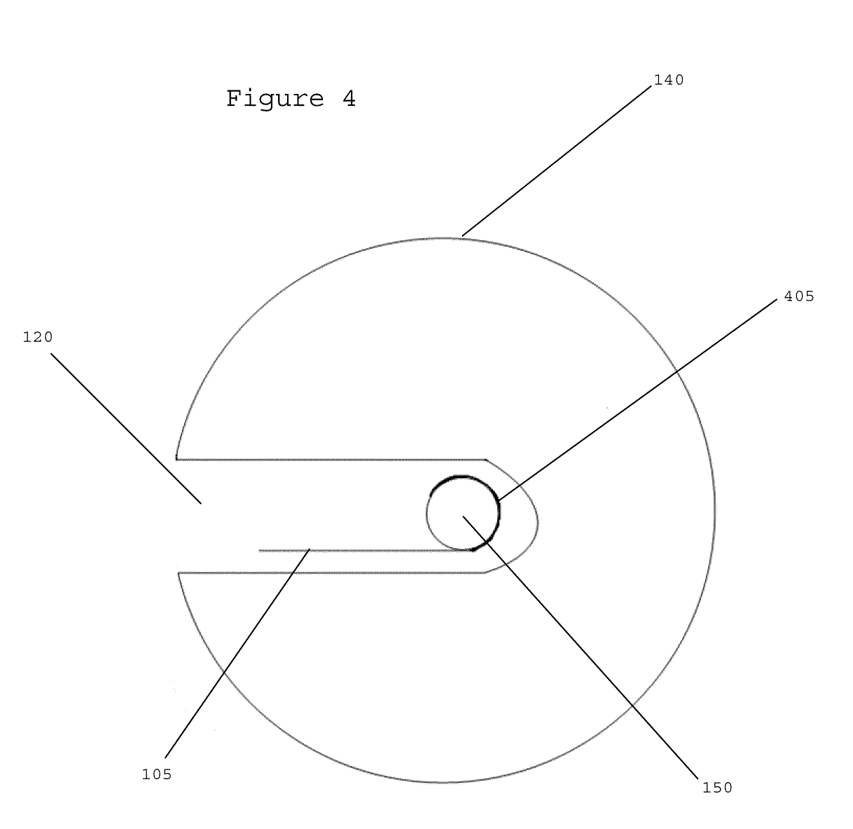

FIG. 4 shows a close-up view of drum 140 after a half rotation has been performed. Tape 105 is further wrapped over wire harness 150 at end portion 405, such that tape 105 is almost completely wrapped around wire harness 150. Tape 105, is drawn further into opening 120, and in further rotations is completely wrapped around wire harness 150.

After a predetermined number of rotations, end portion 145 of tape 105 is completely wrapped around wire harness 150. A new end portion 145 is formed over opening 120, once the rotation has ceased, which allows the user to place the mechatronic tape gun 100 over a further spot on wire harness 150 to continue taping wire harness 150.

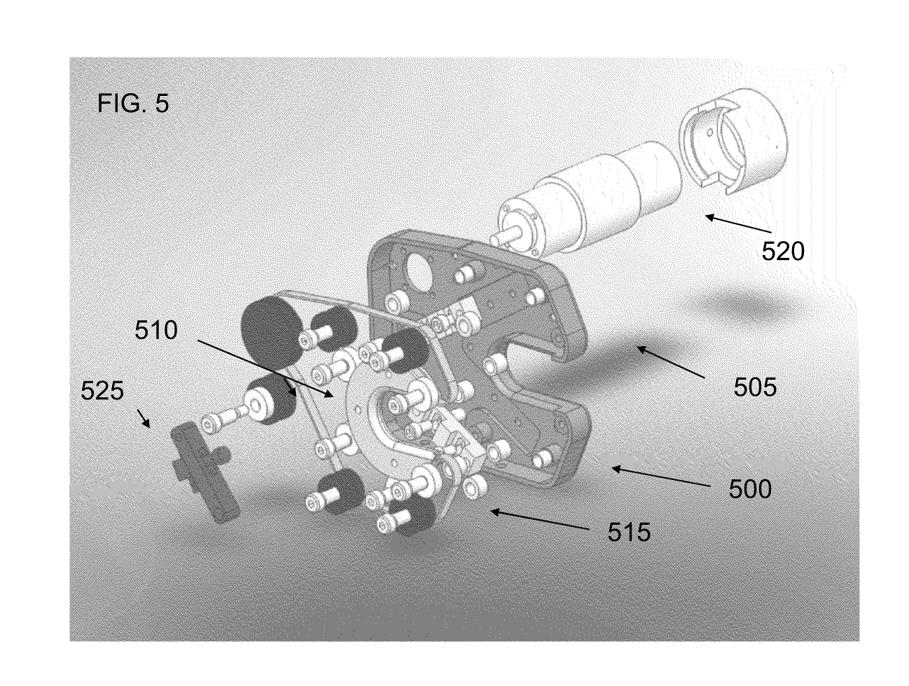

FIG. 5 shows an exploded view of a driving system 500 of mechatronic gun 100. The driving system 500 is mounted on casing 505, which gives traction to the half-closed cylinder 510, transmitting power from the motor through an oblong belt section 515, mounted on 6 ball bearings and rollers mounted on needle bearings which guide the belt. A motorized reduction gear is employed, which may use 24 V direct current 220, and a 280 RPM outlet. In the driving system, a lever-shape belt stretcher 525 is further employed. This stretcher gives the belt the required rigidity to provide it with the proper motor traction transmission.

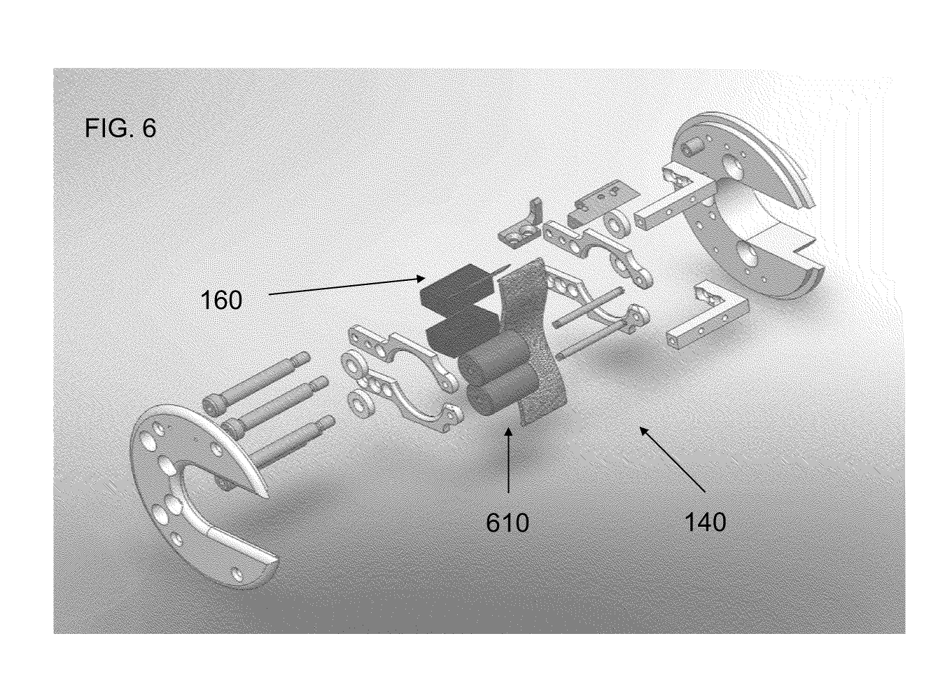

FIG. 6 shows an exploded view of a cutting and fastening drum of mechatronic gun 100. The tape fastener portion 140 is made up of two pivot rollers 610 that are biased together by means of a spring. Pivot rollers 610 make the first contact with the harness 150. Using the pressure of the roller 610, created by a spring, the end portion 145 of tape 105 adheres to the wire harness 150 when wire harness 150 enters mechatronic gun 100 through opening 120. The flexible fastening system is found behind pivot rollers 610 and uses belt stretcher 525 to provide uniform strength on the perimeter of wire harness 150.

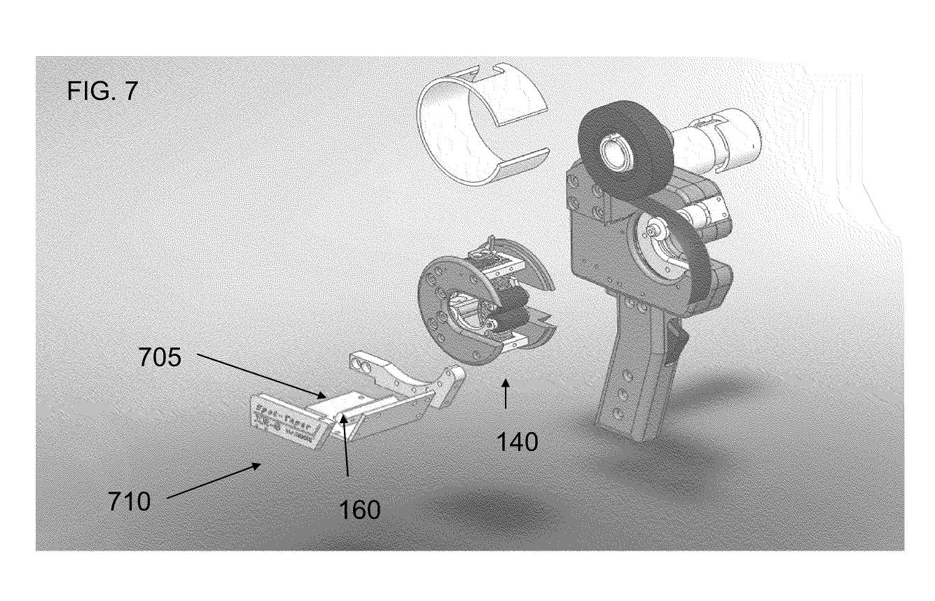

FIG. 7 shows a second exploded view of a cutting and fastening drum of mechatronic gun 100. The cutting and fastening drum 140 may be made of 6061 quality aluminum with a 6061 quality white delrin (polymer) protection guard that is designed to prevent the introduction of objects that might harm the mechanical drum system 140. Drum 140 runs by transmitting traction contained in the driving section. It also contains the mobile cutting system 710 made of steel, tool grade O1 305, triggered by a mechanical device and its buffer is activated each turn of drum 140. In order for cutting system 710 to cut, the required distance from the end portion 145 to the cutting and fastening drum 140 is kept with the buffer 705 that is fixed to the casing. The position of the cutting system 710 can be changed by making a mechanical adjustment to change the length of the tape 105 to be applied on the wire harness 150, which depends directly on the number of desired turns of drum 140 on the wire harness 150 and the outer diameter that make up the set of harness cables of wire harness 150.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A mechatronic dispenser for dispensing tape having an adhesive on at least one side comprising:
a motorized drum with an opening;
a support for holding said motorized drum and said tape;
a switch for activating said motorized drum to rotate within said support; and
a cutter for cutting said tape during said rotation of said motorized drum.

2. The mechatronic dispenser of claim 1, wherein a work piece is inserted into said opening of said drum, and said tape is wound around said work piece.

3. The mechatronic dispenser of claim 1, wherein said support further includes a handle.

4. The mechatronic dispenser of claim 1, further including an adjustment mechanism to control the length of tape and the number of rotations of said motorized drum.

5. The mechatronic dispenser of claim 1, wherein said adhesive tape is one of at least electrical tape, duct tape, packing tape, masking tape, gaffers tape, and plumbers tape.

6. A mechatronic dispenser for winding tape, having adhesive on at least one side, around a work piece comprising:
a support having a housing, a handle and a holder for said tape;
a motorized drum in said housing rotatable with respect to said housing;
said housing and said drum having an aligned radial opening for receiving said work piece;
said tape holder dispensing tape in front of said opening of said housing and said drum in a starting position;
a switch for activating said motorized drum with respect to said housing for at least one rotation to wrap said tape around said work piece; and
a cutter to cut said tape at a predetermined length.

7. The mechatronic tape gun of claim 6, further including an adjustment mechanism to adjust the length of said tape and the number of rotations of said drum.

8. The mechatronic dispenser of claim 6, wherein said work piece is inserted laterally into said opening, adhering to an end of said tape.

9. The mechatronic dispenser of claim 6, wherein said cutter cuts said tape during a first rotation of said motorized drum.

10. The mechatronic dispenser of claim 6, wherein an end portion of said adhesive tape extends over a guide roller attached to said housing and through a slot attached to said housing and extends over said opening of said housing and said drum.

11. The mechatronic dispenser of claim 6, wherein said adhesive tape is one of at least electrical tape, duct tape, packing tape, masking tape, gaffers tape, and plumbers tape.

12. A method of taping a work piece comprising the steps of:
inserting a work piece into a opening of a mechatronic tape gun;
activating a button on said mechatronic tape gun;
wherein said activation of said button causes a rotational movement in a drum about said work piece, attaching and cutting an adhesive tape to said work piece.

13. The method of claim 12, wherein said adhesive tape is one of at least electrical tape, duct tape, packing tape, masking tape, gaffers tape, and plumbers tape.

14. The method of claim 12, wherein a user grips a handle of said mechatronic tape gun and activates said button.

15. The method of claim 12, wherein said user can adjust an adjustment mechanism controlling a length of said tape and the number of rotations about said work piece.

16. The method of claim 14, wherein the number of rotations is 1.

17. The method of claim 14, wherein the number of rotations is greater than 1.

18. The method of claim 12, wherein the adhesive side of said tapes extends outward.

19. The method of claim 12, wherein the adhesive side of said tape faces inward.

20. The method of claim 13, wherein said user removes said mechatronic gun after adhesive tape has been applied and moves said mechatronic gun to a different location on said work piece to attach a further piece of adhesive tape.
